(19) United States
(12) Patent Application Publication
(10) Pub. No.: US 2005/0141842 A1
(43) Pub. Date: Jun. 30, 2005

(54) System and method for providing fiber optic link assurance

(75) Inventor: VanWinkle T. Townsend, Herndon, VA (US)

Correspondence Address: Lockheed Martin Corporation;IPLaw Department, Bldg. 400, Mail Drop 043, 9500 Godwin Drive, Manassas, VA, 20110, US

(73) Assignee: Lockheed Martin Corporation, Bethesda, MD (US)

(21) Appl. No.: 10/435,643

(22) Filed: May 12, 2003

(51) Int. Cl. G02B 6/00

(52) U.S. Cl. 385/140; 385/33

(57) ABSTRACT

In a fiber optic link, adequate optical link performance without unnecessary design margin is attained by providing a fixed or variable valued, electrically enabled attenuator and software that performs and interprets a packet error test. The attenuator, when enabled, inserts an optical light loss into the link without modifying any property of the optical signal that could contribute to additional system power penalties. The software enables a link to send repetitive diagnostic packets and to detect and accumulate packet errors. The operation of the fiber link with the attenuator enabled is extrapolated to the operation of the fiber link with the attenuator disabled. This extrapolation verifies that the link is operating within the specified bit error rate for the link. For duplex links, the packets can be wrapped around at one end to provide a duplex diagnostic test.

### CROSS-REFERENCE TO RELATED APPLICATION

This application claims the benefit of U.S. Provisional Application Ser. No. 60/393,278 filed on Jun. 27, 2002, and which is incorporated herein by reference in its entirety.

### FIELD OF THE INVENTION

The present invention relates to high speed fiber optic data communication links, and in particular, to the in situ estimation of optical power margin through the measurement of fiber optic link bit error rates.

### BACKGROUND OF THE INVENTION

Many high performance electronic systems, both commercial and military, increasingly rely on an infrastructure of high-speed fiber optic data communication links. While there are numerous advantages to such systems, such as large link distance-bandwidth products and decreased cable volume, these systems as presently designed and implemented are not without their shortcomings. For example, due to the nature of digital signaling statistics, a small change in a marginal optical power budget may cause a system's link bit error rate (BER) to degrade from a satisfactory, in-specification operation to an operation characterized by an unacceptable error rate. Also, while individual components of such systems may be tested to determine their compliance with applicable specifications, when these components are assembled into a fiber optic communication system, the resulting end-to-end link performance cannot be bounded based on the testing of individual cable assemblies and link components. Typically, fiber cable assemblies are characterized separately for optical loss and the active elements (receiver, transmitter) are tested by their vendors to meet or exceed the applicable specifications. Unfortunately, these measurements do not and cannot predict the actual operating link margin when the components are concatenated into a total link.

Moreover, while the measurement of optical power is relatively straightforward, the measurement of receiver optical sensitivity requires a time consuming analysis of error statistics as a function of input optical power. In addition, there are many optical signal parameters other than average power that can affect link performance. Any testing operation that opens the link to make measurements loses all knowledge of the mated optical loss at the point of inspection and risks introducing unanticipated loss mechanisms, such as dust particles, upon reestablishing link continuity. These situations and others introduce significant design restrictions and represent a serious reliability exposure for fiber optic locations and platforms in which maintenance is not easily performed, such as submarine, ship and avionic systems.

Since optical receivers do not in general provide a real-time measurement and indication of incident optical power, the small changes in marginal optical power budgets that may lead to unacceptable bit error rates are not easily detectable in a fully operational fiber optic system. In addition, system power penalties are not easily characterized by optical power measurements. Consequently, the problem of unacceptably high bit error rates has typically been addressed by including an unallocated power margin in the link design, with the expectation that the margin would offset any difficult to quantify out of specification conditions caused by the assembly of slightly out of specification components, or any unanticipated optical performance degradation over the effective lifetime of the equipment.

Historically, the rule of thumb for this unallocated power margin was to include an extra 6 dB in the link power budget. As the various potential elements of link performance degradation have been more completely identified and characterized, the unallocated margin requirement has shrunk to 3 dB in typical military systems (see for example MIL-STD-2052(SH) “Fiber Optic System Design”). The provision of a surplus of unallocated margin in the design link power budget however does not insure that a link so designed and built will operate at or below the required BER, nor does it preclude operating a fiber optic link above the maximum specified BER over the service life of the system; it only minimizes the probability of operating above the maximum BER at any given time.

Unfortunately, supporting these excess power margins causes the over-specification of link components resulting in additional costs that realize little or no improvement in link performance. Moreover, specifications for current and anticipated high-speed link protocols specify increasingly smaller link budgets that no longer can practically provide the desired margin. For example, double speed Fiber Channel Standard (2 Gigabaud) in 62.5 μMM fiber at the design link length allocates only 0.10 dB of unallocated margin out of a 6 dB link power budget, with additional allocations of 3.09 dB to inter-signal interference, 1.78 dB for insertion (light) loss, and 0.78 dB for additional link penalties. To add to the problem, industry is currently developing increased link bandwidths of 10 Gbps and 40 Gbps. In light of these increased bandwidths, the additional unallocated link budget becomes prohibitively expensive and is inconsistent with these and other emerging high speed protocol standards. Clearly, an alternative to the traditional excess margin approach must be adopted for applications that require an extra measure of link performance assurance.

### SUMMARY OF THE INVENTION

The present invention provides a method, system and apparatus to estimate in situ the operating link margin of a fiber optic system without physically disturbing or altering the system. Typically, a link operating at or above the minimum receiver optical input power will exhibit so few bit errors that a direct statistically significant measurement of a bit error rate (BER) is impractical or impossible. If a fiber optic system is fitted with an attenuator, the activation of which introduces a known optical loss into the link, the light loss may cause the BER to increase to a point where meaningful measurements of error data can be accumulated in a reasonable amount of time. If no errors occur during the activation of the attenuator (Le., the bit error rate does not increase to a measurable amount), it can be safely assumed that the system is operating within specification. However, there is normally a measurable amount of errors. After the accumulation of the data, a statistical extrapolation with a BER curve determines if the link passes or fails (within a certain confidence level), i.e. if the system performs to the specification standards of the system when the light loss input by the attenuator is removed. As a result, fiber optic systems and links may be designed with a minimal amount of excess margin, and the operation of the system with that selected margin may be tested to insure that it is operating within specification.

Accordingly, it is an object of the present invention to permit the in situ testing of fiber optic links and systems.

It is another object of the present invention to use the results of the in situ testing to determine if the fiber optic system meets the design specifications of the system.

### BRIEF DESCRIPTION OF THE DRAWINGS

FIG. 1 is a diagram of an optical attenuator that may be used in connection with the present invention.

### DETAILED DESCRIPTION OF THE INVENTION

The present invention provides the assurance of adequate optical link performance without unnecessary design margin by incorporating into the system (1) a fixed or variable valued, electrically enabled attenuator, and (2) software to perform and interpret a packet error test. The attenuator may be added to the optical link at any point, including the module transmitter (Tx) output or the receiver (Rx) input, and when enabled, it inserts a known optical light loss into the link without modifying any property of the optical signal that could modify existing system power penalties. The software enables a link to send repetitive diagnostic packets and to detect and accumulate packet errors. For duplex links, the packets can be wrapped around at one end to provide a duplex diagnostic test.

To initiate the packet error test, a known light loss is introduced into the link by applying an electric potential across the attenuator. This light loss is in addition to any unallocated margin designed into the link or system. Since a link operating within specification will have too few errors to be able to get a statistically meaningful count in a reasonable length of time, the attenuator should be designed to increase a marginal link BER well above its design maximum. Diagnostic packets (or a comparable bit stream) are then sent from an initiating network interface card (NIC) to a remote receiver until a predetermined number of bits has been transferred and a number of resulting bit errors accumulated. Since errors are very sparse in a healthy system, packet errors can be assumed to be single bit errors for purposes of the diagnostic. After a specified number of total bits has been transferred, the accumulated error count can be extrapolated into an error rate and confidence factor for the link with the selectable attenuation removed.

For example, it may be desired to establish that a full speed Fiber Channel Standard (FCS) link is operating with at least a 0.5 dB of excess optical power beyond the minimum to sustain the protocol standard 1E-12 bit error rate (BER), i.e., the link is operating with a 0.5 dB margin. If an additional 0.5 dB of attenuation is introduced into the link by the attenuator, and the link is exercised at the maximum transfer rate for 1 minute without error, it may be concluded that, assuming a full 100 Mega Baud/s data transfer rate, the total number of data bits transferred in 1 minute is (60)(800E6)=4.8E10 bits. Using tables of confidence intervals for the mean of a Poisson distribution, the 95% confidence limit for no observed errors is 3.3 errors, or a BER of (3.3)/(4.8E10)=6.8E-11, or 68 times the specified 1E-12 BER. That is, for no observed errors in one minute, one can claim with 95% confidence only that the BER is no worse than a factor of 68 below specification. To continue to test until a statistically significant number of errors can be accumulated with respect to the protocol standard 1E-12 BER is not a practical option.

A preferred alternative to the above test that preserves the efficiency of a short test, while still screening to the 1E-12 specification, is based on an extrapolation as follows. The attenuation is increased slightly to a level that should produce a mean error rate of 3 errors/minute (¾.8E10=6.25E-11 BER) if the link margin were in fact exactly the desired minimum of 0.5 dB. Assuming the usual BER vs. receiver input optical power curve slope of approximately 3 decades/dB, this implies introducing an additional 0.6 dB, or a total attenuation of 1.1 dB. If the packet error test now produces zero (0) errors in a one minute trial, the 6.25E-11 BER is verified at 1.1 dB of margin. Based on the BER curve, this then extrapolates to the desired 1E-12 BER at 0.5 dB of margin. Note that the BER vs. optical power slope of approximately 3 decades/dB is typical for optical receivers limited by Gaussian noise sources. Other receivers may need to have the slope verified by a one time test.

If, on the other hand, the test is not error-free during the first minute, the link need not be summarily failed. For example, successive one-minute test intervals can be chained and the link passed or failed according to the cumulative error count as shown in the following table.

| | Pass | Mean Total | Fail |
|---|---|---|---|
| Test | (.95 confidence) | Errors | (.95 confidence) |
| Duration | (errors/BER) | (6.25E−11 BER) | (errors/BER) |
| 1 min. | 0 error | 3 | 7 errors/1.5E−10 |
| 2 min. | 1 error/1.0E−11 | 6 | 12 errors/1.3E−10 |
| 3 min. | 3 errors/2.1E−11 | 9 | 16 errors/1.1E−10 |
| 4 min. | 5 errors/2.6E−11 | 12 | 20 errors/1.0E−10 |
| 5 min. | 8 errors/3.3E−11 | 15 | 24 errors/1.0E−10 |

If the “Pass” number of errors (or fewer) occurs, the link is accepted with a 5% “User Risk” that the link does not in fact include the 0.5 dB margin. If the “Fail” number of errors (or greater) occurs, the link is rejected with a 5% “Installer Risk” that the rejected link might in fact be acceptable. If the test is continued, a unit should eventually pass or fail as the variance in the error distribution decreases and the pass/fail criteria gradually converge towards the mean.

If the required extrapolation to the 1E-12 BER specification is acceptable, more preferable BER tests can be designed by increasing the test attenuation even further. For example, a test may be designed to produce a mean error rate of 20 errors per minute or a BER of 4.16E-10 for a link with exactly 0.5 dB of margin. The total attenuation would be approximately 1.35 dB. Under these conditions, the preceding table becomes:

| | Pass | Mean Total | Fail |
|---|---|---|---|
| Test | (.95 confidence) | Errors | (.95 confidence) |
| Duration | (errors/BER) | (4.16E−10 BER) | (errors/BER) |
| 1 min. | 12 errors/2.5E−10 | 20 | 30 errors/6.5E−10 |
| 2 min. | 28 errors/2.9E−11 | 40 | 53 errors/5.5E−10 |
| 3 min. | 46 errors/3.2E−10 | 60 | 77 errors/5.3E−10 |
| 4 min. | 63 errors/3.3E−10 | 180 | 99 errors/5.2E−10 |
| 5 min. | 82 errors/3.4E−10 | 100 | 122 errors/5.1E−10 |

Note that by extending the extrapolation from 4.1E−10 to 1E−12, the difference in the “pass” and “fail” accumulated errors is significantly reduced compared to the previous example. This results in fewer marginally performing links that neither pass nor fail and must therefore undergo extended testing or be discarded.

The benefits of incorporating the above diagnostic test into the system design and implementation are twofold. First, regardless of the specific diagnostic test employed, a “Pass” implies that when the attenuator is restored to zero (or minimum), the link will operate at less than the specified BER. Second, the link (and by extension the network if all links are tested) has been determined by direct measurement to be currently reliable. These results are achieved while avoiding the expensive alternative of over-designing the network to include excess signal margin. The attenuator may have a fixed value of attenuation for all applications where a minimum level of performance is to be verified. Alternatively, a variable attenuator may be used in a similar manner to determine the actual value of the operating signal margin.

Furthermore, the traditional design approach of including in a system loss budget all relevant sources of optical loss and system power penalties can be maintained without modification, with the expectation that the unallocated excess margin is reduced to a minimum value to be verified by test, e.g., a 3 dB excess margin may be replaced by a 0.5 dB testable margin. This reduced margin is then verified as part of the build process using the methods described above. Links that fail the margin test should be reworked and retested. A further advantage to this system implementation is that the margin test can be retained as a built-in test (BIT) mode to verify the health of the system at any time, for instance prior to some critical operation of the total system of which the optical links form the data communications infrastructure.

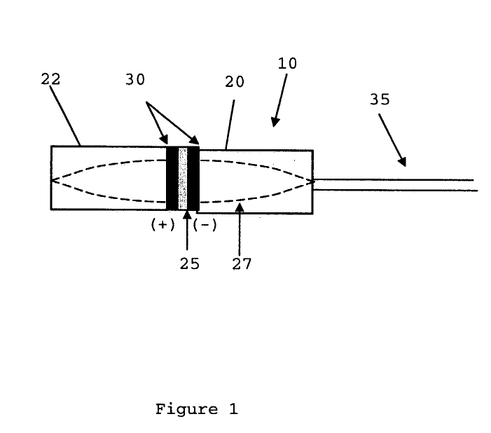

An attenuator 10 that may be used in connection with the above described system and method is illustrated in FIG. 1. The efficacy of an attenuator for the purposes of the present invention depends in part on being able to introduce minimal optical loss (ideally zero) when deselected, have minimal effect on optical parameters other than attenuation (such as relative modal power distribution or time evolution profile in either selected or deselected mode), and have turn-on/turn off times that are less than a second (but which may be much slower than the channel bandwidth). While the attenuator may be placed anywhere in the optical link, the ability to provide a minimum deselected attenuation is greatly enhanced when used as an optical element between the optical fiber and either the receiver or transmitter active devices. As an alternative to the external attenuator of FIG. 1, the effects of the attenuator could be provided electronically as an internal feature of either the receiver or the transmitter.

As illustrated in FIG. 1, an attenuator 10 has two micro-lenses 20 and 22 with a liquid crystal film 25 between the lenses 20 and 22. In a preferred embodiment, the micro-lenses are graded index lenses (GRIN), and the GRIN lenses are quarter pitch. Each lens is coated with a thin, transparent, electrically conducting film 30 (such as tin oxide) to allow a voltage to be applied across the liquid crystal film 25. By choosing a liquid crystal film 25 whose maximum attenuation is limited to the desired optical attenuation, the residual film attenuation can be minimized. The barrel of the micro-lenses 20 and 22 may be metalized to provide an electrical contact to the respective oxide electrode films 30. Optical cable fiber 35 is affixed to the micro-lens 20, and it is optically imaged at the end of the attenuator with micro-lens 22. The fiber image is in every way as effective as the fiber itself in connecting with either an optical source or a receiver detector. By manipulating the micro-lens parameters, the image of the fiber may be projected beyond the physical lens and either magnified or reduced. For example, if the second micro-lens 22 is less than quarter pitch, the focal point will occur outside the lens, resulting in improved coupling to a detector. The micro-lenses can be incorporated into, or even replace, a ferrule in many standard optical connectors. An example of how the micro-lenses 20 and 22 can affect the ray path is indicated by dotted line 27.

The attenuator is activated by applying a potential between the transparent electrodes 30. It is this activation that causes a light loss to be input into the link. Due to the low bandwidths required, the electrical resistance of the electrode films 30 can be very high and consequently highly transparent. If the fiber optic link at issue is a duplex link, attenuators 10 should be placed at the inputs of both receivers.

While the invention has been described in its preferred embodiment, it is to be understood that the words used are words of description rather than limitation and that changes may be made within the purview of the appended claims without departing from the true scope and spirit of the invention in its broader aspects.

1. A method to test bit error rates of a fiber optic data communication link, comprising the steps of:
incorporating into said link an attenuator;
activating said attenuator to insert an optical light loss into said fiber optic link;
transmitting a bit stream over said link;
accumulating bit errors resulting from said transmission; and
extrapolating a first operation of said fiber optic link with said attenuator activated to a second operation of said link with said attenuator deactivated, thereby verifying that said link is operating at a certain predetermined bit error rate and margin.

2. The method to test bit error rates of a fiber optic data communication link according to claim 1, further comprising the step of deactivating said attenuator.

3. The method to test bit error rates of a fiber optic data communication link according to claim 1, wherein said extrapolation comprises the steps of:
increasing the attenuation of said link to produce a predetermined mean error rate;
observing the actual error rate of said link; and
using a bit error rate curve to extrapolate said first operation of said link with said attenuator activated to said second operation of said link with said attenuator deactivated.

4. The method to test bit error rates of a fiber optic data communication link according to claim 3, wherein said actual error rate is zero, thereby indicating that said link is operating within a predetermined bit error rate specification.

5. The method to test bit error rates of a fiber optic data communication link according to claim 3, further comprising the steps of:
observing a non-zero actual error rate during said test;
chaining multiple test intervals together thereby producing a cumulative error count; and
determining whether said bit error rate for said link is acceptable by examining a statistical confidence level table.

6. The method to test bit error rates of a fiber optic data communications link according to claim 3, further comprising the steps of:
increasing further the attenuation of said link; and
determining an actual value of an operating signal margin for said link.

7. An attenuator for a fiber optic link comprising:
a first micro-lens;
a second micro-lens;
a liquid crystal film disposed between said first micro-lens and said second micro-lens;
an electrically conducting film coating said first micro-lens and said second micro-lens; and
an optical fiber cable, said optical fiber cable optically coupled to said first micro-lens and said second micro-lens.

8. The attenuator for a fiber optic link according to claim 7, wherein said optical fiber cable is affixed to said first micro-lens and optically imaged at said second micro-lens.

9. The attenuator for a fiber optic link according to claim 7, wherein said first micr-lens and said second micro-lens are graded index lenses.

10. The attenuator for a fiber optic link according to claim 7, wherein said first micro-lens and said second micro-lens are quarter pitch.

11. The attenuator for a fiber optic link according to claim 7, wherein said second micro-lens is less than quarter pitch, thereby imparting an improved coupling to a detector.

12. The attenuator for a fiber optic link according to claim 7, wherein said electrically conducting film is tin oxide.

13. The attenuator for a fiber optic link according to claim 7, wherein a voltage is applied across said liquid crystal film.

14. The attenuator for a fiber optic link according to claim 7, wherein said first micro-lens and said second micro-lens further comprise a barrel, and further wherein said barrel is metalized to provide an electrical connection between said electrically conducting films.

15. The attenuator for a fiber optic link according to claim 14, wherein said barrel replaces a ferrule in a standard optical connector in said link.

16. The attenuator for a fiber optic link according to claim 7, wherein said attenuator is activated by applying a potential between said electrodes.

17. A method to statistically verify a link optical signal margin for a fiber optic data communication link comprising the steps of:
selecting a bit error rate for said fiber optic link;
selecting a margin for said fiber optic link;
transmitting a bit stream over said fiber optic link;
introducing into said fiber optic link a light loss;
accumulating bit errors for a specified transmission; and
using a bit error rate curve to extrapolate a first operation of said fiber optic link with said fixed light loss to a second operation of said fiber optic link without said light loss.

18. The method to statistically verify a link optical signal margin for a fiber optic data communication link according to claim 17, further comprising the steps of:
increasing said light loss; and
determining an actual value of an operating signal margin for said link.

19. A fiber optic data communication link comprising:
a fiber optic cable;
a transmitter;
a receiver;
an attenuator; and
a programmable processor to alternatively activate and deactivate said attenuator.

20. The fiber optic data communication link according to claim 19, wherein repetitive diagnostic bit packets are transmitted over said fiber optic link.

21. The fiber optic data communication link according to claim 20, wherein the activation of said attenuator causes a light loss to be inserted into said fiber optic link.

22. The fiber optic data communication link according to claim 21, wherein said attenuator is positioned at an output of said transmitter.

23. The fiber optic data communication link according to claim 21, wherein said attenuator is positioned at an input of said receiver.

24. The fiber optic data communication link according to claim 21, wherein said attenuator is integral with said receiver.

25. The fiber optic data communication link according to claim 21, wherein said attenuator is integral with said transmitter.

26. The fiber optic data communication link according to claim 21, wherein said light loss produces an actual error rate in an operation of said fiber optic link at a specified bit error rate.

27. The fiber optic data communication link according to claim 26, wherein said actual error rate is zero, thereby indicating said fiber optic link is operating at said specified bit error rate within a predetermined margin.

28. The fiber optic data communication link according to claim 26, wherein said actual error rate is non-zero, and further wherein said operation of said fiber optic link continues through more than one time interval, and further wherein said actual error rate for said time intervals is accumulated and extrapolated using statistical confidence level tables.

29. The fiber optic data communication link according to claim 21, wherein said light loss permits a determination of an actual value of an operating signal margin for said link.

30. The fiber optic data communication link according to claim 21, wherein said fiber optic link comprises a duplex link, and further wherein said diagnostic bit packets are wrapped around to provide a duplex diagnostic test.
